(19) United States
(12) Patent Application Publication
(10) Pub. No.: US 2017/0015574 A1
(43) Pub. Date: Jan. 19, 2017

(54) WASTEWATER SEPARATION AND PURIFICATION

(71) Applicant: David A. Potts, Killingworth, CT (US)

(72) Inventor: David A. Potts, Killingworth, CT (US)

(21) Appl. No.: 14/800,361

(22) Filed: Jul. 15, 2015

(51) Int. Cl. C02F 3/28

(52) U.S. Cl. CPC C02F 3/28

(57) ABSTRACT

Wastewater settlement and purification are described. These descriptions include purification of organically contaminated wastewater in aerobically maintained processes and anaerobically maintained processes. The wastewater may flow from aerobic processing zones to anaerobic processing zones to subsequent anaerobic or aerobic processing zones. Anaerobic processing may be promoted by accumulating the wastewater above a barrier and then flowing the wastewater below a curtain and then back up and over edges of the barrier for subsequent purification, discharge, environmental recharge and/or reuse.

### TECHNICAL FIELD

The present invention relates to wastewater purification or separation, or both, of contaminants from wastewater. More specifically the present invention relates to using saturated infiltration and treatment media, unsaturated infiltration and treatment media, capture liners, and combinations thereof to promote processes for the purification or separation, or both, of domestic, municipal, or industrial wastewater contaminated with organic material.

### BACKGROUND

Domestic, municipal, or industrial organic wastewater, e.g.: sewage, black water, grey water, food processing wastewater, and slaughterhouse wastewater, are regularly treated by various systems and processes. These systems and processes can serve municipalities, individual dwellings, farming facilities, food processing plants, and other sources as well. Solids removal treatment, followed by purification treatment of the wastewater contaminated by remaining organic waste, are often components of modern wastewater purification and separation systems. As the wastewater is treated, fewer particles and bacteria are suspended by or reside within the wastewater. Solids are separated from the wastewater, and the wastewater is further purified of dissolved and colloidal suspended organic contaminants to a suitable contamination level.

### BRIEF SUMMARY

Embodiments provided herein are directed to processes, devices, and articles of manufacture related to organically contaminated wastewater separation and purification. The wastewater may be generated in various settings including commercial, municipal, industrial, agricultural, and residential settings and may itself include sewage, raw sewage, grey water, black water, food-processing wastewater, plant-farming wastewater, and animal-farming wastewater.

Embodiments may consist of a soil-based leach field that is entirely contained in a liner. Water that is leached may travel through soil or other treatment media and may be captured in the liner. This treated water may then be directed to a storage tank for reuse. Any excess water can overflow the liner and recharge the water table. In embodiments of this system, it is possible to reuse this water and its nutrients for irrigation of plants, an activity that is increasingly prohibited due to water shortages across the world. This water can also be utilized for other reuse purposes such as industrial cleaning, and grey water supply.

In embodiments, treatment may include flowing wastewater through unsaturated and saturated infiltration and treatment media that supports aerobic and anaerobic processing. In embodiments, aerobic purification may be followed by anaerobic purification and the wastewater so treated may then be recharged back to the environment or subsequently stored for reuse. In embodiments, wastewater may be flowed through zones of unsaturated or saturated infiltration and treatment media followed by zones of saturated or unsaturated treatment media and sometimes followed by additional zones of either. These zones may promote aerobic microbial processing, anaerobic microbial processing, or both, of the wastewater flowing through each of the zones.

Vessels providing settlement, storage, treatment and combinations thereof may also be used before, in between, and/or after each of the purification zones. These vessels can serve to remove suspended solids from the wastewater and may employ various treatment techniques to do so. These treatment techniques can include passive systems, such as still ponding for a period of time and active systems such as centripetal force separation and settlement. Filters, dams, and traps may be employed as part of the passive or active systems of these vessels.

In embodiments, wastewater from a residential or commercial source may be flowed into a vessel such as a septic tank or other treatment tank. Wastewater may then flow from the vessel into an upper leaching system having a distribution channel and unsaturated Infiltration and Treatment Media (“ITM”). This unsaturated environment is predominantly aerobic, but can have some anaerobic processes taking place within it. In embodiments, wastewater can travel down through further ITM and enter additional ITM contained by a liner barrier or other barrier material, which may be impermeable to wastewater or allow only a small amount, e.g., 5%-20%, of wastewater from above to pass through the liner. The wastewater can collect in this liner barrier and be retained in saturated conditions, often devoid of oxygen. These conditions and configuration can promote both anaerobic and anoxic reactions serving to process the wastewater.

In embodiments, during processing, wastewater can overflow the impermeable barrier liner and travel around the barrier through a permeable medium and subsequently enter an underlying leaching system beneath the impermeable barrier liner where subsequent leaching provides for recharge back to the environment. This underlying leaching system may itself comprise a collection/distribution channel and ITM and may have saturated and unsaturated zones.

In certain embodiments, another impermeable barrier liner may be installed between the ITM and a vertical portion of the permeable medium and/or barrier to prevent wastewater from short circuiting the ITM and entering the permeable medium near the top elevation of the barrier liner where it overflows the barrier liner. This second impermeable liner, which is preferably upright, can serve to cause the wastewater to move downwardly through the ITM to the permeable medium directly above the impermeable liner. Wastewater can then flow through the permeable medium, between the second barrier liner and the primary barrier liner, and serve to create wastewater ponding to the point where wastewater overflows the primary barrier liner and passes beyond the primary barrier liner.

In embodiments, at various stages of flow, the wastewater may be routed to a vessel for storage and subsequent reuse. The wastewater may be routed to a reuse vessel after anaerobic treatment processing, after aerobic treatment processing, after both, and at various times in the wastewater treatment as well. In embodiments, this reuse vessel may serve as a storage vessel for selective reuse of the wastewater. In other words, wastewater in the reuse vessel, which has been treated in various ways, can be intended for reuse in non-potable or even potable applications. The non-potable applications may include for industrial washing, for bathroom systems or other gray water sources, for landscaping, for irrigation, and in other uses as well.

Embodiments may promote water reuse in various applications and may promote water treatment satisfactory to general users and regulatory agencies. Embodiments can incorporate septic systems with a septic or treatment tank (collectively treatment tanks) and properly designed and sited soil leach fields to provide a high level of treatment and reliability with little maintenance. In embodiments, water may be reused, which may be particularly beneficial where ground water is unusable due to water quality issues or prohibited from use by regulatory agencies. Thus, embodiments can include systems that treat and/or make available water for reuse purposes.

Numerous embodiments are possible beyond those specifically described above in this Brief Summary as well as below. The embodiments described herein are illustrative and should not be considered to be limiting. For example, fewer or more features of a device or system and fewer or more actions of processes may accompany those specifically described herein. Also, processes described herein may be undertaken in various orders unless a specific order is explicitly called for in the applicable claim or description. Likewise, features of the devices and systems described herein may be combined in various ways and shared amongst themselves or in other devices and systems.

### BRIEF DESCRIPTION OF THE SEVERAL VIEWS OF THE DRAWINGS

FIG. 1 shows a side sectional view of a multi-zone wastewater separation and purification system in accordance with embodiments.

FIG. 2 shows a side sectional view of a multi-zone wastewater separation and purification system in accordance with embodiments.

FIG. 3 is a flowchart showing processes as may be employed in accordance with embodiments.

FIG. 4 is a flowchart showing processes as may be employed in accordance with embodiments.

FIG. 5 is a flowchart showing processes as may be employed in accordance with embodiments.

FIG. 6 shows a side sectional view of a multi-zone wastewater separation and purification system in accordance with embodiments.

FIG. 7 shows a side perspective view of a multi-zone wastewater separation and purification system in accordance with embodiments.

FIG. 8 shows a side perspective view of a multi-zone wastewater separation and purification system in accordance with embodiments.

FIG. 9 shows a plan schematic view of a reuse vessel as may be configured in accordance with embodiments.

### DETAILED DESCRIPTION

Embodiments provided herein are directed to processes, devices, and articles of manufacture regarding separation and purification of wastewater. Contaminants of the wastewater can include organic waste such as human waste, animal waste, and food plant waste, as well as other waste where organics are held in suspension or solution with the transport water. Grey water, black water, sewage, and food processing wastewater such as butchering wastewater or food mill wastewater are examples of organically contaminated wastewater.

Advantages of certain embodiments can include that wastewater contaminated with organic waste, including those mentioned above, can be treated to a high purification level while the system itself can occupy a small plan footprint and/or a small profile height, through, for example, the use of low profile stacked leaching systems employing one or more uniquely configured barriers as taught herein. For example, in these leaching systems a bottom barrier may be configured and positioned with a curtain barrier where wastewater flows within the curtain and downwardly through ITM to the barrier, then below the curtain, and then overflows the barrier. This barrier may be an impermeable liner as well as a semi-permeable liner, e.g., where a certain percentage of wastewater can pass through. These barriers may be made from various materials including polymers, metal, compacted bentonite, other clay, and combinations thereof. The liner barriers are preferably made from polymers that may be unrolled and configured to be both durable, e.g. long lasting, and tough, e.g., able to withstand unwanted or unintended forces levied against it

As noted above, advantages of certain embodiments can also include targeted storage and reuse of wastewater after one or more phases of purification or separation. This reuse can include industrial applications such as irrigation, manufacturing/industrial plant cleaning, use as process water, use as thermal conductivity water, and surface cleaning Other applications can include reuse for gray water sources such as toilets and urinals. In preferred embodiments the reused wastewater may be stored ahead of reuse and may be considered non-potable unless additional treatment is performed on wastewater taken from the vessel.

In embodiments, wastewater may be purified and separated by passing the wastewater through sequential zones. One zone may provide for settlement of solids. Another zone may use unsaturated infiltration and filtration media, which can provide an aerobic environment where biologics in that environment can serve to purify the wastewater through degradation or consumption or other processing of organics.

Another sequential zone may be saturated ITM or a saturated collection/distribution channel, which can provide an anaerobic environment. In a saturated zone with anaerobic processes taking place, organics may be further processed to purify the wastewater through anaerobic biologic activities that exist, take place, and survive without oxygen. Like aerobic processes, in anaerobic processes biologics in that environment can also serve to purify the wastewater through degradation or consumption or other processing of organics.

The anaerobic activity in one or more zones may be promoted through the introduction of a carbon source or other promoter. Such carbon source anaerobic promoters can include sawdust, wood chips, liquid carbon, solid carbon in a form such as powder, pellets, and the like, and these carbon sources may be replaced or replenished from time to time. In embodiments, the carbon sources may be preferably maintained in a continually water saturated state to promote the longevity of their use.

In embodiments the wastewater may also optionally be seeded with aerobic microorganisms or anaerobic microorganisms. The applicable organisms may be used to promote or further aerobic processes or anaerobic processes. These organisms may also be used as a catalyst to initiate the applicable aerobic or anaerobic processes in the unsaturated and saturated zones. These aerobic microorganisms or anaerobic microorganisms may be replaced or replenished from time to time.

Aerobic process, aerobic purification, and aerobic process purification indicates the availability of oxygen and use of available oxygen in processes serving to purify the wastewater. These processes may provide and apply various purification mechanisms including the nitrification of wastewater as ammonium is reacted to discharge NO₂, as well as the removal of pathogens, change in Biochemical Oxygen Demand (BOD), reduction of Total Suspended Solids (TSS), and the binding of phosphorus. Aerobic processes entail microorganisms employing oxygen, which is available in a free or dissolved state, to convert organic waste into carbon dioxide and biomass.

Anaerobic process, anaerobic purification, and anaerobic process purification are also used conventionally herein and denote diminished oxygen levels or the unavailability of oxygen and the lack of oxygen use in processes serving to purify the wastewater. These anaerobic processes may provide and apply various purification methodologies and use microorganisms to convert organic waste into methane, hydrogen sulfide, and other products. Anaerobic purification employs hydrolysis and other processes without oxygen.

Thus, in embodiments, microbes may convert organic contaminants in the wastewater into benign resultants. The organic contaminants can in certain instances include fats, sugars, and proteins or other waste products, and the resultants may include carbon dioxide and water for aerobic reactions and methane and carbon dioxide for anaerobic reactions.

As shown in more detail in the accompanying figures and associated text, in embodiments, wastewater may pass through infiltration and treatment media in an unsaturated zone in which predominantly or only aerobic processes take place and then into infiltration and treatment media in a saturated zone in which predominantly or only anaerobic processes take place. Depending upon the saturation level or other factors a zone may accommodate aerobic and anaerobic processes at different times and even at the same time depending upon the amount of available oxygen at a given location. In addition, settlement and/or reuse vessels may be employed throughout this processing to promote settlement of solid waste, reuse of wastewater, and for other reasons as well.

In embodiments, the height of systems may be configured with low profiles and with multiple barriers where one or more of the barriers may be configured in bottom or lower configurations and one or more of the barriers may be configured in upright configurations. When low profiles are employed, the entire system height, including unsaturated and saturated zones, may be three feet in height or have other diminished heights as well, including two feet, four feet, five feet, and six feet, as well as heights intermediate to these.

The barriers may assist in various ways including serving to define the unsaturated and saturated infiltration media zones and by channeling the wastewater into and through the unsaturated and saturated zones, and the various aerobic processing and anaerobic processing zones residing therein. In embodiments, the sizing of the barriers, as well as the management of system wastewater input or other flow, may provide system management where the wastewater may remain in a certain zone for processing and then subsequently be channeled out of the zone when processing is considered to be complete or in overflow conditions or for other reasons as well. The barriers may be comprised of water and gas impermeable materials as well as other materials that allow for only a percentage of water and/or gas to pass through them.

As shown in certain figures, an upright curtain barrier along with a bottom barrier may be employed to create the unsaturated and saturated media, and to channel the wastewater into and out of aerobic processing and anaerobic processing. In other words, the configuration of the barriers, which can include their shape, position, and composition, can serve to define the borders of the saturated and unsaturated zones as well as the positioning, location, and sequencing of aerobic and anaerobic processing characteristics through the zones. Additional materials and/or properties of one or more of the barriers, or materials covering the barriers, may also provide for active movement of wastewater, such as wicking, through and out of a zone.

In embodiments, the ponding and related wastewater contaminant settlement may occur before, between, and after processing (aerobic and/or anaerobic) of the wastewater. The ponding may occur in vessels of various sizes and configurations including settlement tanks, oversized piping, and recessed shaped barriers. In addition, active and passive settlement systems may also be used. Active systems can include, for example, the use of rotational force to accumulate and then later settle out solids from the wastewater while passive systems can include screens or filters. Mixed systems, which have active and passive features can be used as well. Reuse vessels, such as concrete or polymer tanks may be used to capture treated wastewater and hold it for subsequent use by a residential, commercial, or industrial facility.

Furthermore, in embodiments, the aerobic and anaerobic processes and the zones where they occur may not only be atop one another but may have other relative positions as well. For example, in embodiments, aerobic processes and zones where they occur may be adjacent to anaerobic processes and zones where they occur with limited or no overlap. Their shared elevation may also have a limited cumulative height so each are low profile and cumulatively they are low profile as well. Still further, a saturated zone, for example, may have a limited height, i.e. be low profile, while another zone may not employ a restricted height parameter. There may be still further saturated and unsaturated zones with microbial processes employed as well. These zones may also have low aspect ratios as well.

The wastewater purification levels reached in embodiments may enable the wastewater to be discharged in, around, and below the purification and settlement system as well as to surrounding areas. Discharge can serve to recharge the local water sources or may be subsequently recaptured and used for other purposes, such as irrigation or industrial processing. As noted above, wastewater can also be captured and reused in non-potable applications and potable applications, if suitable subsequent treatment is provided.

In embodiments, leaching systems, including distribution channels and collection-distribution channels and ITM, may be positioned above or below the various zones and/or the wastewater water impermeable barrier. Wastewater may flow laterally above and on the barrier while the wastewater is in or below one of the channels. The wastewater may also flow down and around one or more barriers to reach a leaching system below the barrier. Each of these leaching systems, channels, and barriers may be low profile and may also have a low aspect ratio, where its height to width ratio is three to ninety-six or larger.

In embodiments, the wastewater may also be wicked up and over or otherwise around an end or passage of a barrier. For example, the wastewater may flow through an annular channel allowing wastewater passage traversing the barrier. This traversal may be an edge of the barrier as well as in various inner portions of the barrier. Thus, the curtain liner barriers described herein may be in the shape of an upright annular ring, as well as have other shapes and orientations, e.g., be rectangular, polygonal, and have upright positions that vary from 90° (such as 85°, 80°, and 75° from horizontal).

In embodiments, the cumulative height of saturated and unsaturated zones, as well as any upper or lower leaching systems and any intervening barriers, may be three feet or so. Other cumulative heights, such as two feet, four feet, five feet, and six feet, as well as intermediate heights, may also be employed by systems embodying the invention. When embodiments are employed outside in the environment, it may be advantages to use low profile systems where water table levels are shallow. When embodiments are employed inside, as in a manufacturing building, it may be advantages to use low profile systems, with workable space above them, to maximize available manufacturing plant building space.

In embodiments, the water impermeable barrier may be comprised of various materials including polymer sheeting, compacted loose polymer materials, compacted granular materials, bentonite, and other materials configured to prevent water penetration there through. In embodiments, a semi-permeable barrier may also be employed. This semi-permeable barrier may be configured to allow a certain volume or percentage of water to flow there through while the remainder is ponded above the barrier and must flow around the barrier or through holes in the barrier. The semi-permeable barrier may also allow a certain amount or percentage or type of gas to pass there through.

With the use of water impermeable or semi-permeable barriers, aerobic purification of the wastewater may occur above the barrier while anaerobic purification of the wastewater may occur below the barrier. There may also be aerobic zones of purification and anaerobic zones of purification above the barrier as well. The aerobic purification may occur in unsaturated zones with fluctuating wastewater levels further from a bottom barrier liner while the anaerobic purification may occur in zones closer to the barrier liner with saturated infiltration media.

Aerobic zones preferably include areas where the large majority of the microbial purification activity is aerobic in nature. An aerobic zone can have percentages of aerobic microbial processing where the predominant processing is aerobic and the percentage of aerobic microbial processing to total microbial processing can include 60%, 80%, 95%, and 100%.

The anaerobic zone can also include areas where there is aerobic microbial processing. However, these aerobic areas in the anaerobic zone may be more limited than comparative anaerobic areas in aerobic zones, as the anaerobic zone is preferably a completely saturated area devoid of oxygen. Nonetheless, a small percentage of microbial processing in the anaerobic zone may be aerobic in nature due to limited or periodic or unintended access to oxygen.

As noted above, a curtain liner may be employed as one of the barriers. A curtain liner may be configured to have an open bottom or an open bottom portion and may be positioned as to contribute to defining a saturated and unsaturated zone above and/or below the bottom barrier. The curtain liner may have a circular or polygonal plan shape and may be configured with a bottom barrier and treatment media to form a perimeter overflow for wastewater to pass from above the bottom barrier to below the bottom barrier. The curtain liner may also have an open top to allow for wastewater flow into the curtain liner.

The collection or collection/distribution channels can be comprised of various materials including GeoMat™, erosion control mattresses, stone trenches, plastic chambers, drip tubing, fabric wrapped pipe, polystyrene aggregate systems, cuspated systems, prefabricated concrete structures, and other systems utilized for wastewater leach field construction. The use of GeoMat™ may be preferred in embodiments because of its low profile, aerobic nature, and capability to uniformly transition wastewater to an infiltration and treatment medium (ITM).

In embodiments, a treatment gas, such as air or oxygen, may be periodically or continually pumped into the leaching systems. In embodiments, the collection and distribution channels may include piping within it to receive and then distribute treatment gas within and possibly throughout the collection and distribution channels. This piping may be in other parts of the leaching system as well.

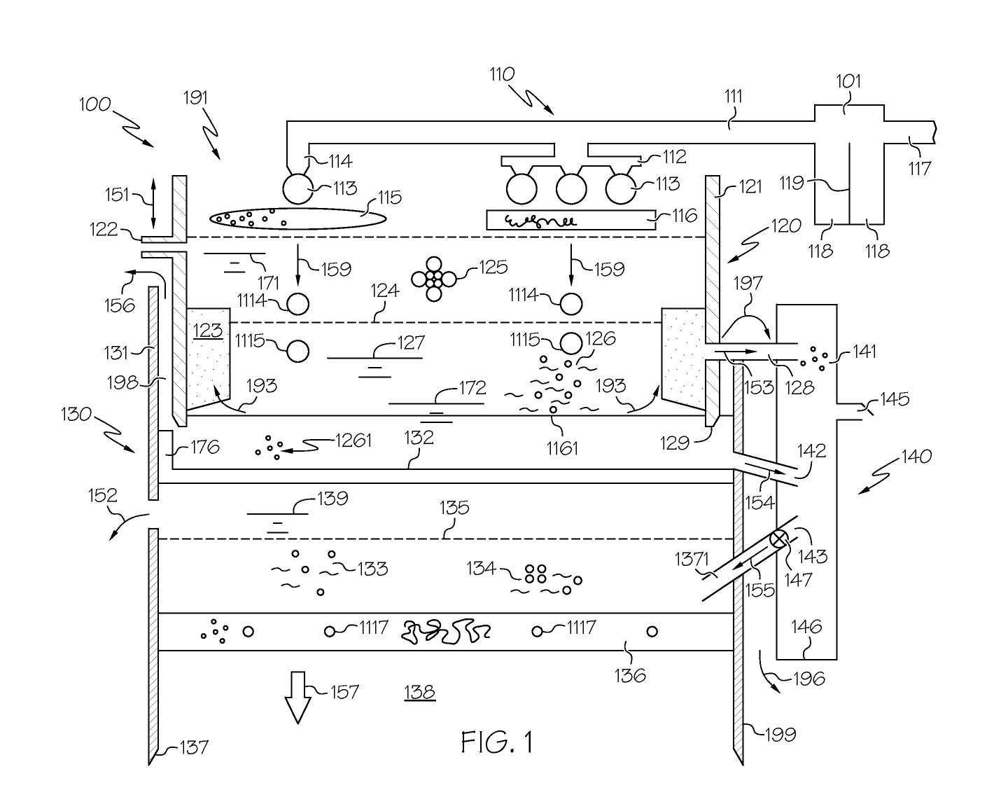

FIG. 1 shows a side sectional view of a multi-zone wastewater separation and purification system in accordance with embodiments. Visible in FIG. 1 is the multi-zone wastewater separation and purification system 100, which includes a wastewater distribution system 110, an open-bottom curtain 120, a vessel 140, and a multi-zone purification stack 130.

The wastewater distribution system 110 in FIG. 1 is labeled with a sedimentation vessel 101 having a vessel outlet 111, a vessel inlet 117, a partition 119, and vessel chambers 118. The vessel outlet 111 supplies supply line 112 and supply line 114, which in turn supply distribution pipes 113. The supply line 112 is shown as a ganged supply line while supply line 114 is a single supply line. Also labeled near the wastewater distribution system 110 is the non-wastewater distribution flow arrow 191. This arrow 191 shows that wastewater may also enter the open bottom curtain 120 without having first passed through the vessel 101 or other parts of the distribution system 110.

Positioned below the wastewater distribution system 110 and within the open bottom curtain 120, are low-profile wastewater distribution channel 115 and low-profile wastewater distribution channel 116. These low-profile distribution channels may have height to width aspect ratios of 3 to as high as 96 or greater and at incremental ratios of that range and may comprise various materials including: GeoMat™, erosion control mattresses, stone trenches, plastic chambers, drip tubing, fabric wrapped pipe, polystyrene aggregate systems, cuspated systems, prefabricated concrete structures, and other systems utilized for wastewater leach field construction. The use of GeoMat™ may be preferred in embodiments because of its low profile, aerobic nature, and capability to uniformly transition wastewater to an infiltration and treatment medium (ITM).

Also positioned within the open bottom curtain 120 are unsaturated porous infiltration and treatment media 125, saturated porous infiltration and treatment media 126, ponding barrier liner 132, and perimeter wicking treatment media 123 Wastewater flow, which is shown by arrows 159, is downward through the unsaturated treatment media 125 and the saturated treatment media 126. When the wastewater reaches the liner 132 it will pond and accumulate.

Also labeled in FIG. 1 are the overflow outlet 122, curtain wall 121, curtain 120 movement arrow 151, which shows how the curtain 120 may move up and down, treatment media saturation transition line 124, variable wastewater level 171, variable wastewater level 172, and variable wastewater level 127, wicking wastewater flow arrow 193, curtain wall rounded edge 129, ponding barrier liner sidewall 176, ponding liner channel 198, ponding liner overflow channel overflow arrow 156, curtain wall overflow arrow 197, replaceable carbon supply 1114 and 1115, and aggregate 1261 of collection/distribution channel 1161.

Furthermore, the vessel 140, of FIG. 1, is labeled with an inlet 128, inlet wastewater flow arrow 153, vessel internal medium 141, overflow or reuse outlet 145, vessel inlet 142, inlet flow arrow 154, vessel outlet 143, vessel outlet flow arrow 155, valve 147, and permeable vessel bottom 146. Overflow arrow 196 shows how wastewater recharge may be sent below the multi-zone purification stack 130 after having overflowed the stack wall 199 as is shown by arrow 197, rather than into the vessel 140.

The reuse outlet 145 may be coupled to a water inlet at a facility, such as a commercial or residential or industrial or agricultural facility, for use by that facility. The facility using the water may be the source facility, or another facility. In other words, after passing through one or more zones of the system 100, wastewater may be collected by the vessel 140 from above the liner 132 and held for a period of time until it may be reused by a source facility or other facility in need of water. In embodiments, the reused water from the vessel 140 may not be potable, but subsequent treatment may render the water portable.

The multi-zone purification stack 130 is shown with wall 131, wall 199, ponding barrier liner 132, a ponding barrier liner sidewall 176, an overflow outlet 152, an outlet 142 feeding the vessel 140, an inlet 1371 receiving flow 155 from the vessel, a maximum water line 139, a treatment media level 135, saturated porous infiltration and treatment media 134, saturated porous infiltration and processing media 133, a low-profile wastewater collection and distribution channel 136, installation edge 137, additional in-situ or placed medium 138, treatment gas distribution channels 1117, and arrow 157 to show subsequent wastewater flow with possible recharge from below the low aspect ratio collection/distribution channel 136.

The gas distribution channels 1117 may be coupled to a gas distribution system that periodically or constantly sends air, oxygen, or another treatment gas into the channel 136. In so doing, the channel efficiency may be improved or otherwise remediated. The gas distribution system may include blowers serving to push or pull gas, and may include management systems to pulse or constantly run the blowers. Sensors may also be employed to monitor the condition of the channel 136, including its saturation and aerobic/anaerobic state as well as the flow rate through the channel 136 and any amounts of biomass or BOD or solids resident in the channel 136.

In embodiments, multi-zone wastewater separation and purification systems, and processes employing fundamentals of them, may provide for purification and separation of wastewater contaminated with organics. The wastewater may be introduced into the system through controlled means such as the vessel 101 and piping 113 shown in FIG. 1. The wastewater may also be introduced through general and previously treated flow. Wastewater may also enter the system without having been previously treated, as shown by arrow 191. The wastewater may then be received by the distribution channels 115 and/or 116 for subsequent distribution further into the system. These channels may provide an aeration effect for wastewater passing through them. The channels may also serve to more broadly distribute the received wastewater below. While channels having a low profile, for example having a height range of three inches to two feet, with aspect ratios of 3 to 96 or more and at incremental ratios of that range, are shown in FIG. 1, embodiments may also employ distribution and collection/distribution channels having other heights and dimensions and shapes as well. The distribution channels and collection/distribution channels in embodiments may be comprised of various materials including GeoMat™, erosion control mattresses, stone trenches, plastic chambers, drip tubing, fabric wrapped pipe, polystyrene aggregate systems, cuspated systems, prefabricated concrete structures, and other systems utilized for wastewater leach field construction. The use of GeoMat™ may be preferred in embodiments because of its low profile, aerobic nature, and capability to uniformly transition wastewater to an infiltration and treatment medium.

In embodiments, wastewater may flow downwards, as shown by arrows 159, through infiltration and treatment media 125. Oxygen is preferably available in this unsaturated zone such that the wastewater flowing there though may be aerobically treated as it moves through the treatment media 125. Flowing downward, the wastewater may accumulate on the barrier 132 and pond above it in and above collection/distribution channel 1161, with the standing water level varying depending upon entering flow rates and treatment flow rates. Various water levels are shown by levels 171, 127, and 172.

The height of inlet 128, when considered in relation to the configuration of the curtain 120 and the wall 131, may serve to set a saturation line 124 transitioning between the treatment media 125 and the treatment media 126. As wastewater accumulates above this line, its standing pressure would serve to force wastewater below it through the perimeter 123 and out towards the vessel 140. If wastewater accumulates too quickly for the size of the inlet 128, the wastewater may also overflow as show by arrows 156 and 197. A third overflow outlet is also indicated at 122.

Thus, while in use, wastewater can pass beyond the channels 115 and 116 and into unsaturated porous infiltration and treatment media where the wastewater can be purified in an aerobic fashion. In other words, maintaining an unsaturated zone below the channels 115-116 provides for a zone of aerobic processes acting to purify the wastewater.

Below this unsaturated treatment media the wastewater enters a saturated zone with the transition 124 between the saturated and unsaturated zone. As the wastewater enters and leaves the system, this transition line 124 would raise and lower accordingly. While in the saturated zone, the wastewater can be purified in an anaerobic fashion before leaving. The perimeter 123 may have wicking properties that allow wastewater to be lifted and wicked up into the inlet 128. In so doing, the saturated zone can fall below the bottom elevation of the inlet 128.

As can be seen in FIG. 1, the bottom of the perimeter 123 does not reach the barrier liner 132. As such, wastewater would remain standing below the perimeter 123 provided that the barrier liner 132 is water impervious. If the barrier liner allows for some penetration of wastewater there through, then the transition line 124 and associated water level can drop even further and closer towards the liner 132 and below the bottom of the perimeter 123. As the transition line 124 drops, so too would the lower water level line 172 and the amount of saturated ITM. Without being bound by theory, it is believed that this up and down movement of the transition line and wastewater level serves to further assist in the purification of wastewater as anaerobic processes in the saturated porous ITM is not set at a stagnant level but can be purged from time to time and be refreshed by aerobic cleansing activities when the unsaturated zone grows. However, in preferred embodiments the water level line will remain fairly stable, so as to prolong the useful life of carbon supplements, which can degrade quickly though the periodic introduction of oxygen. Still further, some ITM's will retain water through capillarity or other processes and in so doing the carbon source or surroundings may remain wet, moist, or damp, even though the water line has dropped below them.

The perimeter 123 wicking material may be comprised of various materials including tightly bound polymer nettings and sponging materials. The ponding liner sidewall is shown at 176 and can serve to form a tub of liner material or other ponding shape of liner material. When passing through the vessel 140 and the vessel 101, contaminants of the wastewater may be separated out through settlement or other forms of filtration. These vessels may be tanks and may contain interior baffles, materials, and other configurations. As noted above, the vessel 140 may serve as a reuse vessel, where water retained in the vessel 140 may be reused by a source of the wastewater or by another entity. Also, in embodiments, the vessel 140 may receive inlets from other portions of the system in addition to or instead of the placement of the inlets 128 and 142. Valves may also be present in each of these inlets to control vessel inlets and system flow.

The collection/distribution channel 1161 is shown occupying most if not all of the space immediately above the liner 132 and is positioned to extend below the wall 121. In so doing, the channel 1161 can both receive wastewater from above and also provide management of movement of the wastewater atop the barrier 132 and outside of the curtain liner 120 for subsequent processing.

After passing out of the open bottom curtain area 120, either through the barrier liner 132, or the inlet 128, or the overflows 156 and 197, wastewater can enter the purification stack 130. The stack 130 may include saturated porous infiltration and processing media 134 reaching a level of line 135 while wastewater may reach a level of 139, which is set by the elevation of outlet 152. The low profile wastewater collection/distribution channel 136 may serve to further purify and separate the wastewater as it moves through this anaerobic zone or may serve to simply receive and direct wastewater flow. Purification in the channel 136 may be effected by anaerobic activities, while separation may be effected by mechanical filtering activities of the ITM or the material of the channel.

Once having passed through the channel 136, the wastewater may pass through more saturated or unsaturated ITM 138, be aerobically processed or anaerobically processed as this area may be saturated at times and unsaturated at times, and then be recharged to the environment. Wastewater may also not pass through the channel 136 and may instead overflow though outlet 152, again here being recharged to the environment in certain embodiments. In other embodiments the outlet 152 may be connected to another vessel or recharge mechanism to recirculate some or all of the wastewater back through the system 100 or to send stored wastewater back to the source of the wastewater or another facility for subsequent use.

The installation edge 137 may be pointed and can assist in pile driving or otherwise locating the stack 130 into an installation location, such as native soil or granulated stone. The stack 130, like the curtain 120, may be made from various flexible and rigid materials. The flexible materials may require additional support in order for them to maintain shape. When rigid materials are used, e.g., concrete or steel, these rigid materials may serve to ease in-ground installation techniques by enabling downward pressure, like pile driving, installation processes. When the systems are used above-ground, the rigid curtain and stack may have other advantages including providing safe containment and/or providing structural support for other collateral purposes, such as serving as a support for factory floor or wall.

Thus, these and other embodiments may be integrated for use into still other systems.

The inlet 142 and outlet 143 are shown with pitches to promote fluid flow, which are preferred in certain embodiments. The permeable vessel bottom 146 can be selected to have a porosity that allows a percentage of the wastewater to flow downward and out of the vessel to recharge the environment. In embodiments this percentage can be 10%-40% or more and at incremental ratios of that range.

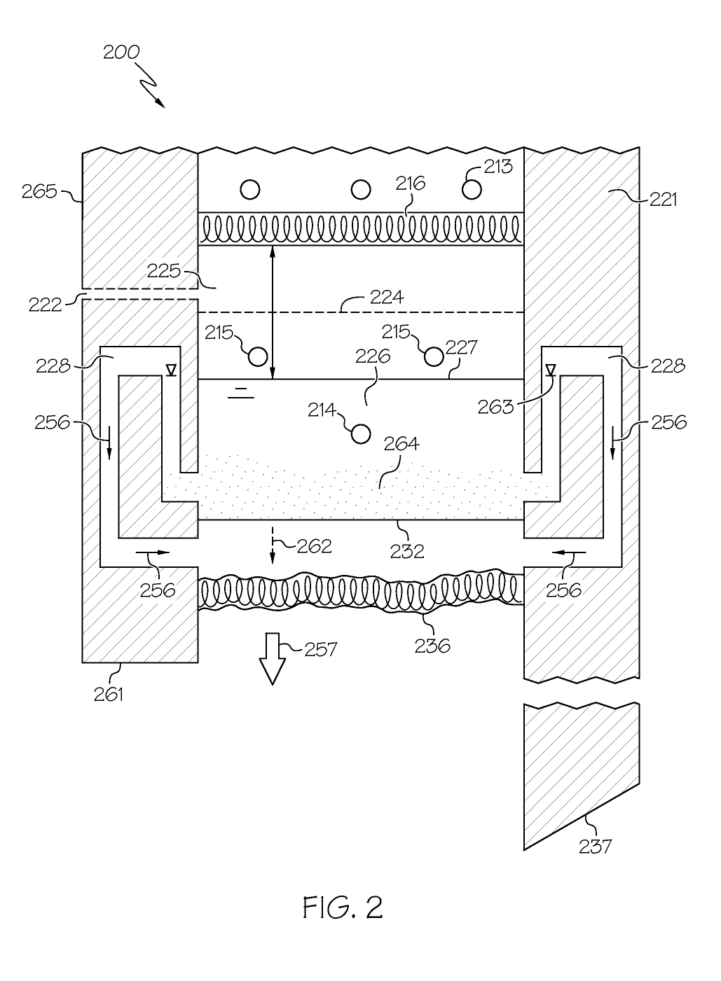

FIG. 2 shows a multi-zone wastewater separation and purification system 200. This system 200 includes leaching pipes 213, a low aspect ratio wastewater distribution channel 216, treatment media transition 224, unsaturated porous infiltration and treatment media 225, saturated porous infiltration and treatment media 226, wall overflow outlet 222, ponding liner overflow arrows 256, ponding liner overflow 228, water line 263, a ponding barrier liner 232, an open interior wall 221, an outer surface 265, a level bottom 261, installation edge 237, low aspect ratio collection/distribution channel 264, and a low aspect ratio wastewater collection/distribution channel 236. Arrow 262, in system 200 shows subsequent wastewater flow that may pass through the liner 232, as does arrow 257, which shows subsequent wastewater flow that has passed through the channel 236 for possible recharge to the environment.

Like the system 100, the system 200 may be constructed out of various materials with the walls fabricated out of concrete, or polymers, or steel. During installation, the system 200 may be assembled away from its final deployment position and then later lifted into place and/or secured into place. Placement and securement can be, for example, by pile driving the system 200 into soft soil or sand or by excavating and placing the system 200 into the excavation or by bolting the system to the floor of a slab foundation. As noted above, the installation edge 237 shows that the system 200 may be configured for pile driving or other pressure installations. Still further, the system 200 may also be low profile, having a limited height and may be suitable for internal installation and use. For example, the overall height of the system 200 may be six feet or less and may be located on the floor of a plant, with workspace or storage above to preserve space.

The operation of the system 200 may include wastewater leaching from leaching pipe 213 entries into low-profile wastewater distribution channel 216. The wastewater above liner 232 can fluctuate up or down depending upon the volume of wastewater entering and exiting the system. The ponding liner 232 may allow for some wastewater to flow through it, and some wastewater may also exit the system 220 completely by passing through overflow outlet 222. The wastewater level 227 may fluctuate up and down, increasing or decreasing the amount of saturated and unsaturated treatment media. In the unsaturated area, aerobic purification of the wastewater may occur. In the saturated area, anaerobic purification of the wastewater may occur. Separation of solids from the wastewater may also be carried out as the wastewater passes through the media both above and below the ponding liner 232.

The ponding liner overflow 228 is positioned within the walls of the system 200. This configuration and location within the walls allows for easy construction and installation of the system. The ponding liner overflow 228 allows for transport of water from above the ponding liner in the saturated infiltration treatment media to below the ponding liner, and into a low aspect ratio wastewater collection and distribution channel 236. This low aspect ratio wastewater collection/distribution channel 236 can serve to further separate and purify the wastewater, as well as provide for subsequent wastewater flow recharge 257 into the environment. The channel 236 may be saturated, providing for anaerobic processes, or it may be saturated periodically with periods of time where it and its surroundings below the liner 232 are not saturated. When this area below the liner and the channel 236 itself are not saturated, aerobic processes may be employed and serve to further purify the wastewater.

In use, the wastewater level may rise and fall, bounded by an upper limit set by the outlet 222 and a lower limit set by the overflow 228. Below the lower limit, anaerobic processes are preferably employed to purify the wastewater. Anaerobic and aerobic processes may be employed depending upon the actual level of the water line. When saturated conditions exist, anaerobic processes would preferably be in process; while in unsaturated zones, when useable oxygen is present, aerobic processes would be at play. There may be a transition zone in the treatment media where at some areas or some time periods anaerobic processes are being employed while in other areas or time periods aerobic processes are being employed.

A carbon supply may be provided though outlets 214 and 215. In this and other embodiments, carbon may be provided to promote anaerobic processes. In preferred embodiments the carbon will be deployed in saturated zones to promote longevity and higher efficiencies of the carbon in promoting anaerobic processes.

The system 200 of FIG. 2, like other embodiments, may also have a low profile and low aspect ratio, where its height to width aspect ratio of the side profile of the system is 3 to 96 or higher and includes increments in that range. Thus, for a system that is three feet high, its side width would be nine feet or more.

A reuse vessel may also be used in conjunction with embodiments, including the system 200 of FIG. 2. This reuse vessel may receive wastewater from above or below the liner 232 and may store the wastewater for subsequent use by a source of wastewater, such as a residence, an industrial plant, and a commercial location, or by another facility.

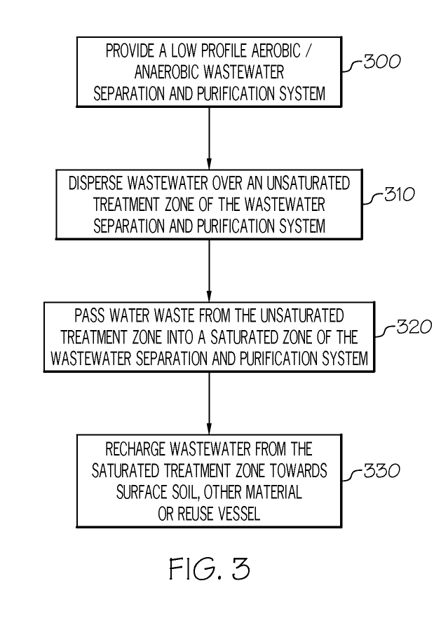

FIG. 3 shows a process of multi-zone wastewater separation and purification in accordance with embodiments. As shown at 300, a low-profile aerobic zone/anaerobic zone wastewater separation and purification system may be provided. As shown at 310, wastewater may be dispersed over and into an unsaturated treatment zone of the wastewater separation and treatment system. As shown at 320, wastewater may pass from the unsaturated treatment zone into a saturated treatment zone of the wastewater separation and purification system. And, as shown at 330, wastewater may be recharged from either treatment zone toward a subsoil surface or other material or reuse vessel. This process may employ various features and techniques shown herein, including the low profile and low aspect features as well as the side curtain and bottom curtain features of the preceding and the reuse vessel as taught herein.

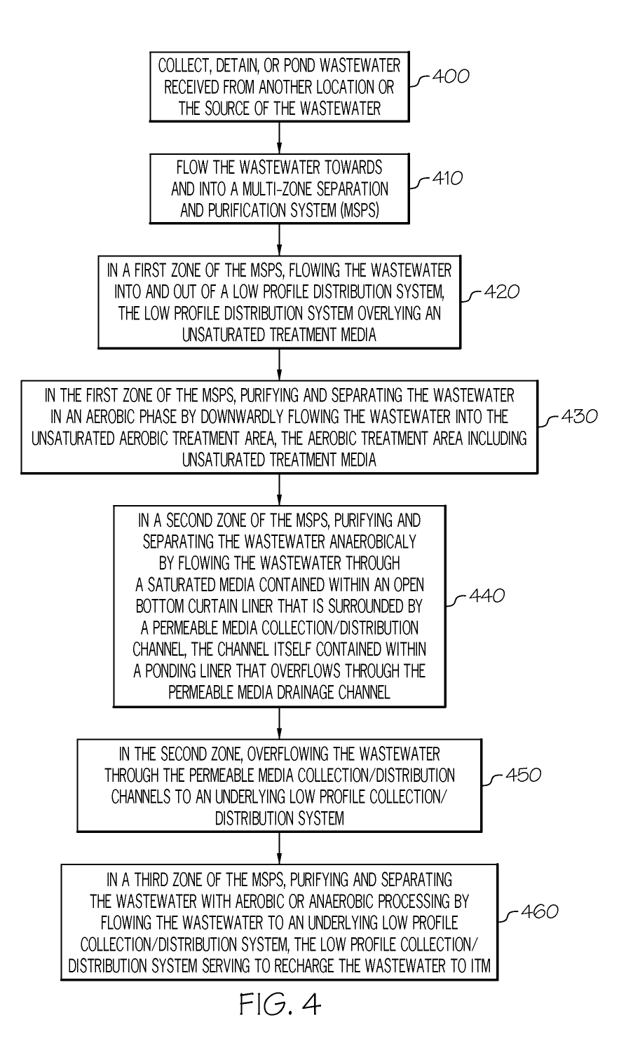

FIG. 4 shows a process of multi-zone wastewater separation and purification in accordance with embodiments. As shown at 400, wastewater may be collected, detained, or ponded from another location or the source of the wastewater. As shown at 410, the wastewater may be flowed towards and into a multi-zone separation and purification system “MSPS”. As shown at 420, in the first zone of the MSPS, wastewater may be flowed into and out of a low-profile distribution system where the low-profile distribution system overlies an unsaturated aerobic treatment area. As shown at 430, in the first zone of the MSPS, the wastewater may be purified and separated in an aerobic phase, by downwardly flowing the wastewater into the unsaturated aerobic treatment zone, where the unsaturated aerobic treatment zone includes unsaturated aerobic treatment media. As shown at 440, in the second zone of the MSPS, the wastewater may be further purified and separated in an anaerobic phase by flowing the wastewater through a saturated media contained within an open bottom curtain liner that is surrounded by a permeable media collection/distribution channel. Here, wastewater may be contained within a ponding liner and overflow through the permeable media collection/distribution channel. This collection/distribution channel may take on an annular shape and many other shapes as well to conform with a barrier liner and a curtain liner. As shown at 450, in the second zone the wastewater may overflow through the collection/distribution channels to an underlying low-profile distribution system. And, as shown at 460, in the third zone of the MSPS, the wastewater may be further purified and separated in an anaerobic or aerobic phase by flowing the wastewater to an underlying low-profile collection/distribution system where the low-profile system can serve to recharge the wastewater to surrounding environment. As in other embodiments, settlement vessels may be employed before or after any or all of the treatment zones. Thus, the wastewater in step 410 may be been previously retained in a settlement vessel. Likewise, wastewater leaving the first zone or the second zone or both may also be retained in a storage vessel ahead of continuing to the next zone of processing and separation or for recirculation back to a source of wastewater for use by that source, e.g. a residence, a commercial location, and an industrial location. Also, processes provided herein may employ various features and techniques shown herein, including the low profile/low aspect ratio aspects and the side curtain and bottom curtain features of the preceding and following embodiments.

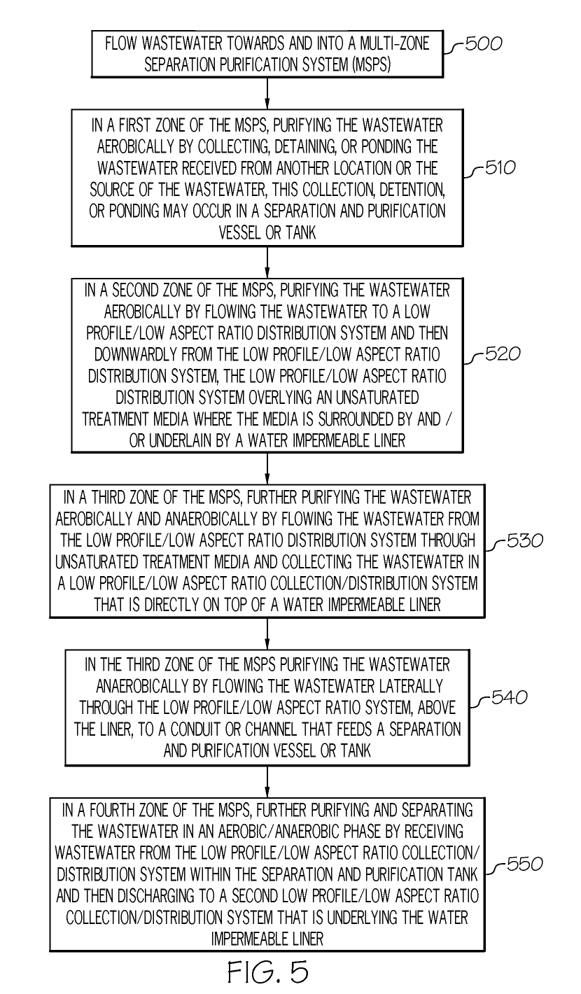

FIG. 5 shows a process employing a wastewater multi-zone separation and purification system MSPS. As shown at 500, wastewater may be flowed towards an MSPS. Next, as shown at 510, in a first zone of the MSPS wastewater may be separated by collecting, detaining, or ponding the wastewater received from another location or the source of the wastewater, where this collection, detention, and ponding can be effected in a separation and purification vessel or tank.

Next, as shown at 520, in a second zone of the MSPS, the wastewater may also be purified aerobically by flowing the wastewater to and through a low-profile/low aspect ratio distribution system and then downwardly from the low-profile/low aspect ratio distribution system where the low-profile/low aspect ratio distribution system overlies unsaturated treatment media that is itself surrounded by and underlain by a water impermeable liner. As shown at 530, in a third zone of the MSPS, the wastewater may be further anaerobically purified by flowing the wastewater from the low-profile/low aspect ratio distribution system through saturated treatment media and collecting the wastewater into a low-profile/low aspect ratio collection/distribution system that is positioned on top of a water impermeable liner.

As shown at 540, in the third zone of the MSPS, the wastewater may also be purified in an anaerobic phase by flowing the wastewater laterally through the low-profile/low aspect ratio collection/distribution system, above the liner, to a conduit or channel that feeds a separation and purification vessel or tank. And, at 550, the process may further include, in a fourth zone of the MSPS, further purifying and separating the wastewater in aerobic or anaerobic phase by receiving wastewater from the low-profile/low aspect ratio distribution system within the separation and purification vessel and then discharging to a second low-profile/low aspect ratio collection/distribution system that is beneath the water impermeable liner.

As in other embodiments, settlement vessels may be employed before or after any or all of the treatment zones and phases of treatment. Thus, the wastewater in step 520 may have been previously retained in a second settlement vessel. Likewise, wastewater leaving the first zone or the second zone or both may also be retained in a storage vessel ahead of continuing to the next phase of processing and separation. In addition, these settlement vessels may also provide for recirculation of wastewater back to the source or other facility for reuse by the source or other facility. Also, this process may employ various features and techniques shown herein, including the low profile aspects as well as the side curtain and bottom curtain features of the preceding and following embodiments.

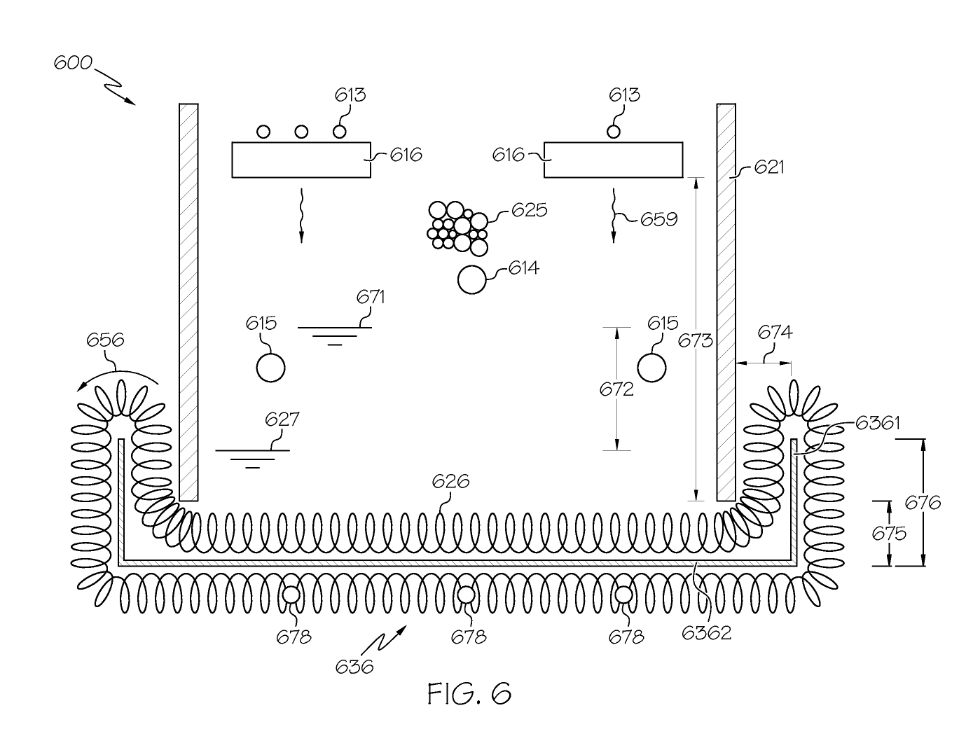

FIG. 6 shows a multi-zone wastewater separation and purification system 600 where the system includes leaching pipes 613, low-profile wastewater distribution channels 616, unsaturated porous infiltration and treatment media 625, subsequent wastewater flow arrows 659, wastewater level 627, wastewater level 627, curtain wall 621, porous saturated collection/distribution channel 626, ponding liner overflow arrow 656, offset distance arrow showing ponding liner overflow channel dimension 674, wastewater downward flow distances 673, wastewater fluctuation range 672, overflow to liner sidewall height 676, curtain wall bottom channel dimension 675, carbon source outlets 614 and 615, and low-profile wastewater collection/distribution channel 636.

In embodiments, such as the system 600, wastewater may be ponded above a barrier and subsequently overflowed. The ponding can provide for saturated and unsaturated infiltration and treatment media where the aerobic and anaerobic activity can occur in sequence depending upon the water level and amount of saturation. The anaerobic processes may be maintained or enhanced through carbon sources introduced or replenished using the outlets 614 and 615. These carbon sources for microbial aerobic processes here within the system, in this and other embodiments can include: sawdust, wood chips, liquid carbon, sugar, corn syrup, ethanol, and other possible materials having available carbon for bioconsumption. In preferred embodiments, the largest bulk of the carbon sources will be maintained in saturated zones immediately below unsaturated zones.

Wastewater may flow laterally along the bottom of the liner and be pushed upwardly through the space 674 between the wall 621 and the liner wall 6361. The distance between the bottom of the wall 621 and the liner 6361 is shown by 675 while the height of the wall 6361 is shown by 676. The low water level is indicated by line 627 while the upper water level is indicated by line 671. The sizing of the gap 675 and the wall height 676 can be used to determine the amount of standing water inside the curtain walls 621 and the flow rate through the infiltration media within the curtain walls and along the bottom barrier. The distribution and collection/distribution channels may be various media. For example, GeoMat™, erosion control mattresses, stone trenches, plastic chambers, drip tubing, fabric wrapped pipe, polystyrene aggregate systems, cuspated systems, and other systems utilized for wastewater leach field construction may be used. The use of GeoMat™ may be preferred in embodiments because of its low profile and resiliency. Likewise, the collection/distribution channels 636 below the liner 6362 may also be comprised of GeoMat™, erosion control mattresses, stone trenches, plastic chambers, drip tubing, fabric wrapped pipe, and polystyrene aggregate systems, cuspated systems. The collection/distribution channels may have height to width aspect ratios of 3 to 96 or more and at incremental ratios of that range. Treatment gas supply lines 678 may be located below the liner 6362 and in the medium 636. These lines may be coupled to a gas supply that provides treatment gas, such as air or oxygen, to the medium 636 on a periodic, sporadic, and/or constant basis.

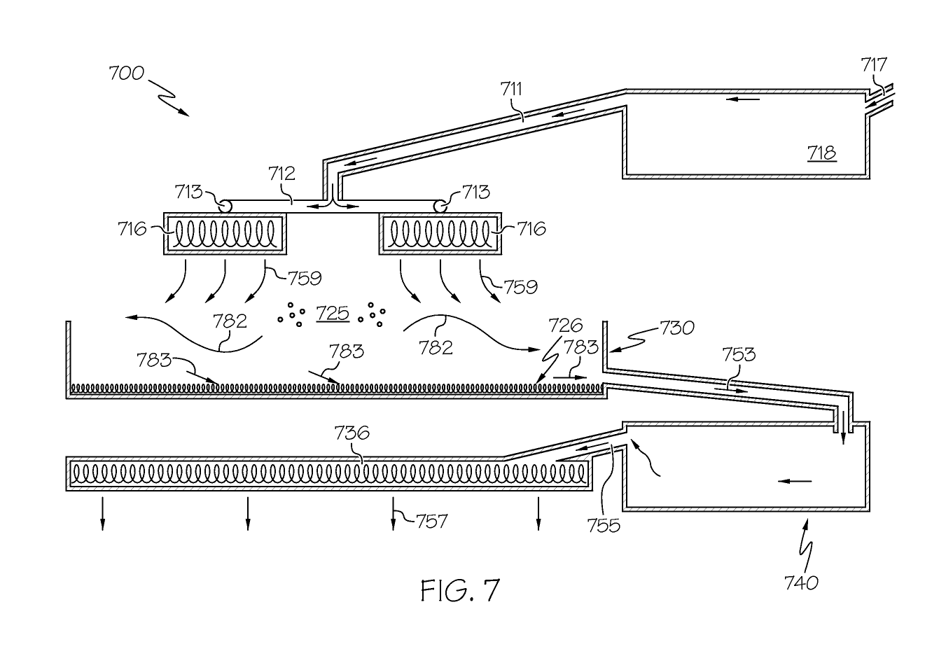

FIG. 7 shows a multi-zone wastewater separation purification system 700. Labeled in FIG. 7 are vessel outlet 711, vessel inlet 717, vessel or tank 718, distribution line 712, leaching pipes 713, low-profile wastewater distribution channels 716, subsequent wastewater flow arrows 759, unsaturated porous infiltration and treatment media 725, wastewater flow arrow 783, wastewater flow arrow 782, saturated porous infiltration and treatment media 726, bottom barrier 730, wastewater flow arrow 753, vessel tank 740, outlet flow 755, low-profile wastewater collection/distribution channel 736, and subsequent wastewater flow to recharge 757.

Evident in FIG. 7 are the tanks 718 and 740, which are positioned atop one another. Also evident in FIG. 7 is that wastewater flow 782 can move substantially parallel to the bottom of the barrier 730. As can be seen, this barrier may be in the shape of a tub. Accordingly, wastewater flowing from the channels 716 may pass through infiltration and treatment media and be aerobically processed before reaching the media 726, where the wastewater will be anaerobically processed and can flow laterally along the bottom barrier before exiting to the vessel and entering the channel 736. The height of the system 700 may be considered a low profile system, where the distance between the pipe 712 and the channel 736 is three feet or the aspect ratio as measured from this same distance when compared to the length of the media 726 is three or greater.

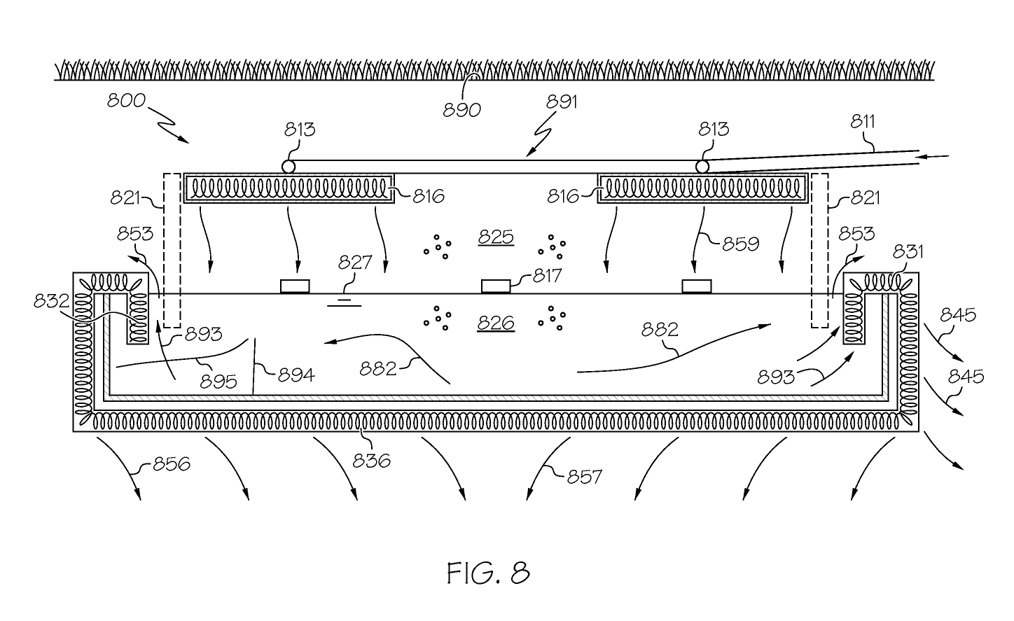

FIG. 8 shows a multi-zone wastewater separation purification system 800. Labeled in FIG. 8 are grass surface 890, leaching pipes 813, non-wastewater distribution system input flow 891, vessel outlet 811, low-profile wastewater distribution channels 816, unsaturated porous aerobic infiltration and treatment media 825, subsequent wastewater flow arrows 859, variable water line 827, wastewater flow arrows 853, internal wastewater flow arrows 893, bottom barrier liner 894, internal wastewater flow arrows 882, side barrier liner 895, saturated porous infiltration and treatment media 826, overflow to surrounding environment arrows 845, subsequent wastewater flow to possible recharge 857 arrow, wastewater recharge to the environment arrow 896, and low-profile wastewater collection/distribution channel 836.

FIG. 8 shows how wastewater flows horizontally, as shown by arrows 882, and can be wicked up and out of a barrier liner as shown by arrows 893 and 853. Arrow 891 also shows how water or wastewater may enter the system 800 without first passing through inlet 811 or low profile distribution channels 816.

In use, solids from wastewater may be settled in a vessel, such as a settling tank, and pass through vessel inlet 811. Wastewater may then be passed to distribution channels 816 via pipes 813. As wastewater passes through the treatment media 825, aerobic processes may act to purify the water. Additional carbon sources, such as sawdust and woodchips, may be fed into the system 800, below the channels 816, via channels 817. These carbon sources will preferably be maintained near or within treatment media that is continually saturated with wastewater. In this embodiment, the channels 817 feed the carbon source downward so it lies along the variable water line 827.

Having passed though the treatment media 825 and any added carbon sources, the wastewater may then accumulate in the treatment media 826. This treatment media is preferably maintained in a saturated condition in order to promote anaerobic processes for purifying the wastewater. The curtain 821 may extend down and into the saturated treatment media and may be configured such that wastewater may accumulate above the liner 894 and such that wastewater may be forced, by head pressure, from the liner at the edges of the liner, as shown by arrows 893 and 853. Thus, wastewater may be forced downward and under an edge of the curtain 821 from the inside of the curtain and may emerge on the outside of the curtain where it can flow over and out of the containment of the liner. This flow is shown by arrows 882, which shows internal flow within the channel, substantially along the liner 894 and then upwards as shown by arrows 893 and 853. Once emerged, the wastewater may then overflow to the environment as shown by arrows 845 and may also flow further through the collection/distribution channel and possible recharge of the environment as shown by arrows 857. The wastewater may also be gathered and flowed to a vessel for reuse as discussed herein in other embodiments.

As shown in FIG. 8, the top of the curtain 821 may have various elevations, where some curtains reach to the top of the channel 816 while others can reach to the ground surface 890. Other configurations are also possible in embodiments. Here, as well as in other embodiments, the distribution and collection/distribution channels may be comprised of various materials, including GeoMat™, erosion control mattresses, stone trenches, plastic chambers, drip tubing, fabric wrapped pipe, polystyrene aggregate systems, cuspated systems, prefabricated concrete structures, and other systems utilized for wastewater leach field construction.

As can be seen in FIG. 8, the collection/distribution channel 836 may be configured to have an inwardly facing portion where upright portions of the liner 894 and 895 are covered on the outside by the channel material, along the top by the channel material 831 and on the inside by the channel material 832. This channel material on the inside 832 and along the top 831, in addition to allowing for wastewater flow there though, may also have wicking properties that draw the wastewater up and through the channel 832 and 836. This wicking can assist standing head pressures exerted on water retained by the liner to have the wastewater moved from within the liner to outside the liner.

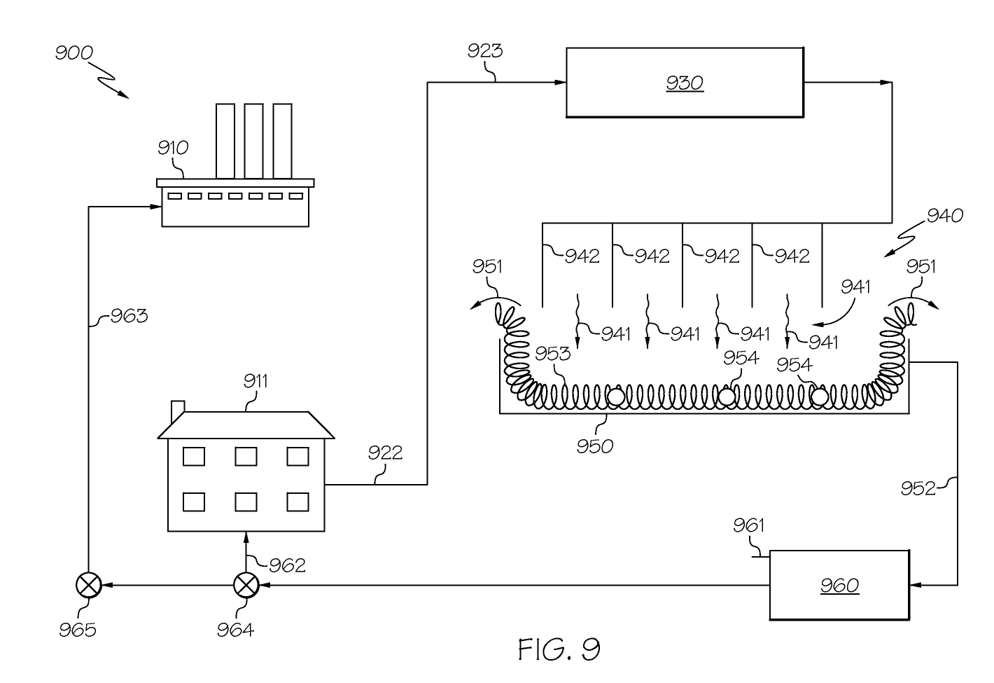

FIG. 9 shows a schematic of embodiments employing a barrier and reuse vessel in accord with embodiments. Labeled in FIG. 9 are the system 900, industrial facility 910, residence 911, wastewater output 922, combined treatment vessel input 923, treatment vessel 930, leaching system 940, low aspect ratio distribution channels 942, wastewater flow 941 through infiltration and treatment media, low aspect ratio collection/distribution channel 953, barrier 950, wastewater overflow 951, reuse vessel input 952, reuse vessel 960, reuse vessel overflow 961, reuse control valves 964 and 965 and reuse input lines 962 and 963.

In embodiments, a system may receive wastewater from a single source such as 911 or 910 and from multiple sources. This wastewater may be routed to a treatment vessel, such as 930, where it may then be distributed via distribution channels 942. The wastewater may the flow through infiltration and treatment media as shown by arrows 941, where the media may be unsaturated and saturated and employ techniques taught herein. Wastewater may then accumulate above a barrier liner 950 or other barrier and may then flow to a reuse vessel 960 where it may be sent back to one of the sources or another location. The reuse vessel 960 may have an overflow outlet 961 to manage water levels and may also employ other management techniques to receive and move the water into and out of the vessel. In embodiments, treatment gas may also be flowed to or from the media via pipes or other channels as is shown by 954. The treatment gas may be air, oxygen or other gas.

In FIG. 9, the reuse tank is shown to feed residence 911 and/or facility 910. Other entities and buildings may also receive reused water. For example, the residence 911 may be multiple apartment buildings or a single cabin or multiples houses. Likewise the facility may be industrial, agricultural, or commercial in nature and may be a single or multiple buildings and facilities. Valves 964 and 965 may be used to control where flow from the reuse tank 960 is sent.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operation, elements, components, and/or groups thereof.

The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated.

What is claimed is:

1. A method of water treatment including separation and purification, the method comprising:
flowing wastewater from a treatment tank to an upper low profile distribution system that is overlying an unsaturated treatment media;
flowing water downwardly from the upper low profile distribution system through the unsaturated treatment media and then through a saturated media contained within a open bottom curtain liner,
the open bottom curtain liner surrounded on at least a portion of its outside perimeter by a permeable media collection-distribution channel,
the channel also contained within at least a portion of a tub liner and positioned above or approximate to a bottom surface of the tub liner,
the channel overflows wastewater between the tub liner and the curtain liner for one or more of the following: reuse or to flow to a treatment device, or to flow to an underlying low profile collection-distribution system for recharge of treated wastewater.

2. The method of claim 1 wherein the permeable drainage channel extends beyond and outside the curtain liner and upwards once outside the curtain liner and is fluidly connected to the underlying low aspect ratio distribution system.

3. The method of claim 1 wherein the curtain liner comprises one or more of plastic or concrete or metal or masonry and wherein the low profile distribution system is contained above-ground and contained within a processing plant or manufacturing facility.

4. The method of claim 1 wherein the low profile distribution system has an overall system height and an overall system width and the aspect ratio of this system width to system height is three to ninety-six or greater.

5. The method of claim 1 further comprising:
providing a replaceable carbon source into the treatment media.

6. The method of claim 5 wherein the carbon source is positioned below the low profile distribution system, the carbon source comprising one or more of sawdust, wood chips, liquid carbon, or peat-moss.

7. The method of claim 1 wherein the low profile distribution system extends beyond the outer perimeter of the tub liner.

8. The method of claim 1 where at least a portion of the wastewater is recirculated back to a storage tank.

9. The method of claim 1 wherein the collection-distribution channel extends upwards along an outside surface of the curtain liner.

10. The method of claim 1 wherein the permeable media channel between the tub liner and the curtain liner has an annular shape.

11. The method of claim 1 wherein the upper low profile distribution system and the underlying low profile collection-distribution system each have an aspect ratio of three or greater and up to 96.

12. A method of water treatment including separation and purification, the method comprising:
flowing wastewater from a treatment tank to a low aspect ratio distribution system that is overlying an unsaturated treatment media, the unsaturated treatment media underlain by a tub liner;
flowing wastewater downwardly through the unsaturated treatment media and collecting it in a permeable media low aspect ratio collection-distribution channel that is directly on top of the tub liner; and
flowing wastewater laterally through the low aspect ratio collection-distribution channel above the tub-liner, to a treatment tank, said tank configured to discharge to a low aspect ratio distribution system.

13. The method of claim 12 wherein the tub liner serves to contain the wastewater and wherein wastewater overflows from the tub liner after passing through or beneath a curtain liner that is configured to retain the wastewater and develop pressure on the wastewater serving to force the wastewater from inside the curtain liner to outside the curtain liner.

14. The method of claim 12 wherein the low aspect ratio distribution system is entirely below the impermeable tub liner.

15. The method of claim 12 wherein the low aspect ratio distribution system is entirely underlying the impermeable tub liner.

16. The method of claim 12 wherein the low aspect ratio distribution system is at least partially below the impermeable tub liner and the low aspect ratio distribution system is spaced apart from the impermeable tub liner.

17. The method of claim 12 wherein the low aspect ratio distribution system is at least partially underlying the impermeable tub liner.

18. A sequential wastewater treatment system for separation and purification the system comprising:
a first low aspect ratio distribution channel receiving wastewater from a treatment tank and discharging the received wastewater to unsaturated treatment media;
a first low aspect ratio collection-distribution channel positioned to capture wastewater from above, the first collection-distribution channel comprising saturated permeable media;
a tub-liner positioned below the first low aspect ratio collection-distribution channel, the tub liner preventing or retarding wastewater flow through the liner,
a curtain liner, the curtain liner positioned above the tub-liner and at least some of the collection-distribution channel with an open of filled space between the curtain liner and the tub-liner;
a second low aspect ratio collection-distribution channel, the second low aspect ratio collection-distribution channel configured to receive wastewater that has previously passed through the first low aspect ratio distribution channel,
wherein the second low-aspect ratio collection-distribution system is positioned below the tub-liner,
wherein the first low-profile collection-distribution channel is a saturated environment.

19. The system of claim 18 wherein an overflow is at least partially defined by the curtain liner and a bottom or side or both of the tub-liner.

20. The system of claim 18 further comprising:
an access channel configured to replenish a carbon source for anaerobic consumption within the unsaturated treatment media, the access channel having a discharge area positioned within a saturated area.

21. The system of claim 18 wherein the overall height of the sequential wastewater treatment system is less than five feet.

22. The system of claim 18 wherein the overall height of the sequential wastewater treatment system is less than three feet.

23. A water purification system comprising:
a treatment tank;
a soil based leach field contained in a liner; and
a storage tank,
wherein the soil based leach field is configured to receive water from the treatment tank,
wherein the liner is configured to direct flow to the storage tank,
the storage tank overflowing to the liner if water is not used, and
the liner overflowing water directly or indirectly back to the environment.
